(19) United States
(12) Patent Application Publication
(10) Pub. No.: US 2026/0005855 A1
(43) Pub. Date: Jan. 1, 2026

(54) CHIPLET SiP - SECURING SUPPLY CHAIN INTEGRITY WITH SECURE-IP IN INTERPOSER/BRIDGE

(71) Applicant: Microchip Technology Incorporated, Chandler, AZ (US)

(72) Inventors: Abhinay Venuturumilli, Gilbert, AZ (US); Bomy Chen, Newark, CA (US); Anu Ramamurthy, Newbury Park, CA (US)

(73) Assignee: Microchip Technology Incorporated, Chandler, AZ (US)

(21) Appl. No.: 18/891,710

(22) Filed: Sep. 20, 2024

Related U.S. Application Data
(60) Provisional application No. 63/665,363, filed on Jun. 28, 2024.

(51) Int. Cl. H04L 9/14

(52) U.S. Cl. CPC H04L 9/14

(57) ABSTRACT

To protect chip intellectual property disclosed to supply chain foundries and assembly sites, an aspect stores chip logic for a chip function in an interposer. A method provides an interposer substrate; provides a data storage device in the interposer substrate and comprising chip logic to perform a chip function; and provides a via or connection in the interposer substrate between a bond pad and the data storage device. A system has an interposer comprising: an interposer substrate, a data storage device in the interposer substrate and comprising chip logic to perform a chip function; and a chip in signal communication with the interposer, wherein the chip does not comprise the chip logic, wherein the chip is to perform a function via the chip logic of the interposer.

### PRIORITY STATEMENT

This application claims priority to U.S. Provisional Patent Application No. 63/665,363 filed Jun. 28, 2024, the contents of which are hereby incorporated in their entirety.

### TECHNICAL FIELD

The present disclosure relates to assembled dies and interposers assembled in system-in-packages, in particular, it relates to security of intellectual property and use of authorized components, such as chips and chiplets, assembled in system-in-packages.

### BACKGROUND

Chips and chiplets provide functional modules in different process technologies. Individual dielets typically communicate through interposers, RDL interposers, or bridges. A dielet is a realized chip. Dielets are modular and flexible where they can be easily combined into single package to enable customization and scalability for heterogeneous integration, which combines chips made in different process nodes onto a common substrate.

Individual dielets/chips are fabricated at various foundries. Assembly sites assemble dies into system-in-packages (SiP). However, companies that are intellectual property developers, and therefore owners of chip intellectual property provide instructions for the assembly and creation of chip SiPs, but have limited control over the supply chain foundries and assembly sites that actually manufacture the chip SiPs. The owners of the chip intellectual property significantly depend on the supply chain foundries and assembly sites to maintain security, reliability, and sustainability, with limited control from the intellectual property developers and owners of the chip intellectual property. This inability to control the supply chain could lead to overbuild for counterfeit products that can be used for unintended target applications and could be considered a national security issue. A malicious entity may create counterfeit products as long as they can procure the dielets by assembling these into SiP and using them for non-intended usage. With most of the foundries and chip assembly sites in foreign countries, there is limited control and oversight to ensure supply is not going to unintended users to produce counterfeit products.

There is a need to protect chip and chiplet intellectual property disclosed to supply chain foundries and assembly sites.

### SUMMARY OF THE INVENTION

According to an aspect, there is provided a method comprising: providing an interposer substrate; providing a data storage device in the interposer substrate and comprising chip logic to perform a chip function; and providing a via or connection in the interposer substrate between a bond pad and the data storage device.

An aspect as in the preceding paragraph comprises providing a chip that does not include the chip logic.

An aspect as in one of the preceding two paragraphs, comprises assembling the chip and the interposer so that the chip is operable to perform a function of the chip logic via the chip logic of the interposer.

An aspect as in one of the preceding three paragraphs, wherein the chip logic comprises logic to perform a function of the chip or block a function of the chip.

An aspect as in one of the preceding four paragraphs, wherein the chip logic comprises cipher-based verification logic to use a symmetric key and a derived key, wherein the symmetric key is to comprise a diversified symmetric key and the derived key is to be derived from a master key.

An aspect as in one of the preceding five paragraphs, wherein the chip logic comprises Public Key Infrastructure (PKI) based certificate authentication logic.

An aspect as in one of the preceding six paragraphs, wherein the chip logic comprises logic to boot with a symmetric key or a public/private key.

An aspect as in one of the preceding six paragraphs, wherein the chip logic comprises logic to verify a power or signal signature of a chip.

According to an aspect, there is provided a device comprising: an interposer substrate; a data storage device in the interposer substrate and comprising chip logic to perform a chip function; and a via or connection in the interposer substrate between a bond pad and the data storage device.

An aspect as in the preceding paragraph provides wherein the chip logic comprises logic to perform a function of a chip or block performance of a function of a chip.

An aspect as in one of the preceding two paragraphs, wherein the chip logic comprises cipher-based verification logic to use a symmetric key and a derived key, wherein the symmetric key is to comprise a diversified symmetric key and the derived key is to be derived from a master key.

An aspect as in one of the preceding three paragraphs, wherein the chip logic comprises Public Key Infrastructure (PKI) based certificate authentication logic.

An aspect as in one of the preceding six paragraphs, wherein the chip logic comprises logic to boot with a symmetric key or a public/private key.

An aspect as in one of the preceding six paragraphs, wherein the chip logic comprises logic to verify a power or signal signature of a chip.

According to an aspect, there is provided a system comprising: an interposer comprising: an interposer substrate; a data storage device in the interposer substrate and comprising chip logic to perform a chip function; and a chip in signal communication with the interposer, wherein the chip does not comprise the chip logic, wherein the chip is to perform a function via the chip logic of the interposer.

An aspect as in the preceding paragraph provides, wherein the chip logic comprises logic to perform a function of the chip or block performance of a function of the chip.

An aspect as in one of the preceding two paragraphs, wherein the chip logic comprises cipher-based verification logic to use a symmetric key and a derived key, wherein the symmetric key is to comprise a diversified symmetric key and the derived key is to be derived from a master key.

An aspect as in one of the preceding three paragraphs, wherein the chip logic comprises Public Key Infrastructure (PKI) based certificate authentication logic.

An aspect as in one of the preceding four paragraphs, wherein the chip logic comprises logic to boot with a symmetric key or a public/private key.

An aspect as in one of the preceding five paragraphs, wherein the chip logic comprises logic to verify a power or signal signature of a chip.

### BRIEF DESCRIPTION OF THE DRAWINGS

The figures illustrate examples of an interposer comprising functional chip logic and a chip that does not include the functional chip logic, wherein the chip and the interposer are assembled, wherein the chip at least partially operates via the functional chip logic of the interposer.

FIG. 1 shows a perspective view of dies assembled into a system-in-package (SiP), wherein logic functionality to the interposer/substrate such that the chip is not functional without that logic.

FIG. 2 shows a perspective view of dies assembled into a system-in-package (SiP), wherein chip logic functionality is moved to the interposer/substrate such that the chips are not functional without that logic, and fake logic blocks are added to the interposer/substrate to make it more difficult to reverse engineer the interposer/substrate.

FIG. 3 shows a lateral cross-sectional view of a multi-chip IC package that includes a plurality of chips mounted on an interposer, which in turn is mounted on a substrate.

FIG. 4 is a block diagram of circuitry that includes one or more processors operably coupled to one or more data storage devices.

FIG. 5 shows a method to protect chip intellectual property disclosed to supply chain foundries and assembly sites.

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DESCRIPTION

According to an aspect, there is provided an interposer comprising functional chip logic and a chip that does not include the functional chip logic, wherein the chip and the interposer are assembled, wherein the chip at least partially operates via the functional chip logic of the interposer.

As used herein, “chip” means chip, chiplet, dielet, any type of semiconductor die, e.g., a field programmable gate array (FPGA) or other processor die, a microcontroller, a serial/deserializer (SerDes) die, a memory die, or any other type of die.

Chips may be high-end process node technology. These chips may be placed on interposers and bridges (to communicate across multiple chips). The interposers and bridges may be on 65 nm process nodes to build the chip system in a package (SIP). Interposers and bridges are typically considered as “taken for granted” and non-active components, which purpose is just to hold multiple chips of the SIP. Aspects provided leverage interposers and bridges to provide control of chip logic intellectual property in supply chain contexts. Logical components and circuits from the chips may be integrated into the interposer and bridge functionality. On bootup or during periodical processing, the chip may check to determine if it is placed on a trusted interposer, and if yes, the chip would function on the trusted interposer. When the same chip is placed on a non-trusted interposer, it wouldn't function at all, or it may perform with limited or reduced functionality or features. To ensure malicious actors cannot replicate the interposer with same circuit(s) or logic from the chips, additional non-functional (fake) blocks may be added on the interposer along with functional components to obfuscate the intruder trying to reverse engineer the interposer.

By ensuring that the interposer is authenticated to verify trustworthiness by the chips, if a foundry or sub-contractor becomes unreliable, the supply chain can maintain intellectual property integrity because the interposer can be controlled from a trusted and reliable entity. Because an interposer or bridge may be on legacy nodes and may be manufactured at facilities not requiring high-end leading edge process nodes, the interposer or bridge may be manufactured, and the system may be assembled at a trusted site.

One aspect moves non-timing logic functionality to the interposer or substrate such that the chip is not functional without that logic. A further aspect adds additional non-functional (fake) blocks on interposer along with functional components to obfuscate the intruder trying to reverse engineer.

When the system is assembled with the authentic interposer or bridge (that has the corresponding logic), the chip based system would perform as per specifications. However, if the system is assembled with an unauthorized interposer or bridge, the system may not function as specified.

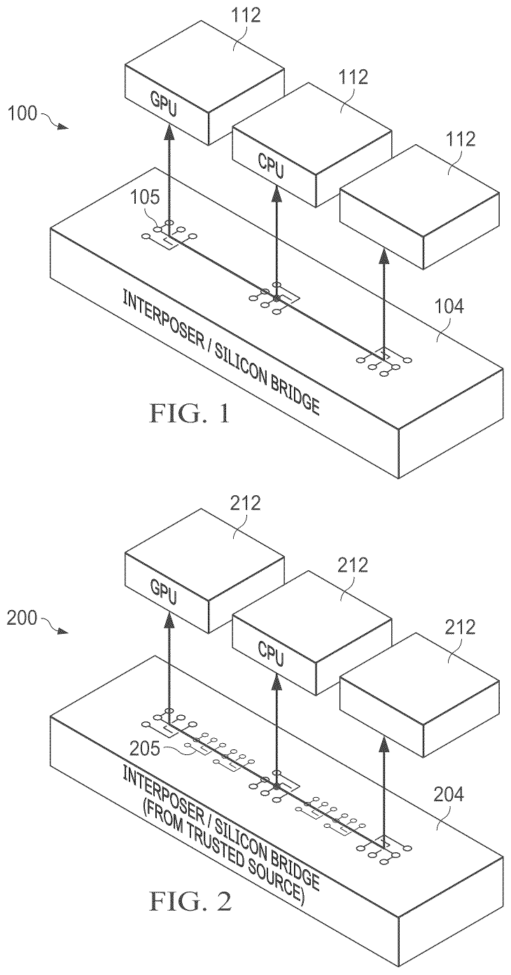

FIG. 1 shows a perspective view of chips 112 assembled into a system-in-package (SiP), wherein logic functionality to the interposer or substrate such that the chip is not functional without that logic. Functional circuit blocks from chips 112 are built into the interposer 104 by storing chip logic in data storage devices 105. The chips 112 connected to this circuit block interposer silicon bridge or interposer 104 may fully function as predicted.

FIG. 2 shows a perspective view of chips 212 assembled into a system-in-package (SiP) 200, wherein chip logic functionality is moved to the interposer 204 such that the chips 212 are not functional without that logic, and fake logic blocks are added to the interposer 204 to make it more difficult to reverse engineer the interposer 204.

The interposer 204 may hold some chip logic from the chip 212 by storing chip logic in data storage devices 205, so the chip 212 can confirm it is placed on a “trusted” interposer 204 by confirming the logic on the interposer 204.

One aspect may apply a cipher-based secure verification. A challenge/response with a symmetric key/derived key may be used. A challenge-response authentication mechanism using symmetric keys involves a two-party system (chip and interposer) where one party (the host) verifies the identity of the other party (the peripheral) by challenging it to provide a valid response to a randomly generated challenge. Host can be either interposer or chip depending on the specific subsystem and scenario. When using diversified symmetric keys, each peripheral has a unique symmetric key derived from a master key, which adds an extra layer of security. Implementing diversified keys would further add security. Diversified keys may ensure that even if one key is compromised, other keys remain secure, thereby mitigating the risk of a single key exposure.

Alternatively, Public Key Infrastructure (PKI) based certificate verification may be used. Private key provisioned/generated within the interposer: PKI based certificate authentication offers ability for the chip to authenticate the interposer using certificate verification. PKI leverages asymmetric cryptography to ensure secure data transmission, with public and private keys that verify identity and protect data integrity. Individual interposer keys are given a certificate by a trusted certificate authority and provisioning these certificates within interposer is expected to happen within a trusted environment. Internally generated and stored or Physical Unclonable Function (PUF) based key creation may also be used. An interposer can have a private key injected into the device by an external provisioning system or can generate a private key with an internal random number generator (RNG) and store in volatile/nonvolatile memory (with required tamper protections).

Still further, a secure boot with symmetric key or public/private key may be used. An interposer can authenticate the image of the firmware when a chip retrieves the firmware image from an external flash chip, where the interposer can be on the same bus and can detect the authenticity of the image before the processor chip can start executing the image for further functions.

Another aspect provides signal integrity of the interposer. A chip may verify the integrity of the interposer by verifying the power/signal integrity signature. A power signature, using Digital Signal Processing (DSP)/ADC, may be applied for systems that can process analog signals, firmware can use DSP/ADC techniques to measure signal signature as the signal is sent via the interposer and received back. Voltage and current monitoring may be used where DSP/ADC can detect patterns or fluctuations that are inconsistent with the expected behavior of genuine hardware. Time Domain Reflectometry (TDR) may be applied where DSP can use TDR techniques to send signals through circuit and measure reflections and verify the reflection profile. Power consumption profile may be applied in system to measure the power consumption of the interposer communication to validate the fingerprint.

The chip may comprise any type of semiconductor die, e.g., a field programmable gate array (FPGA) or other processor die, a microcontroller. a serial/deserializer (SerDes) die. a memory idea, or any other type of die. The chip may include at least one bond pad formed in a passivation region. The bond pad may be formed from copper (Cu), aluminum (Al), nickel (Ni), gold (Au), or any other suitable bond pad material. The passivation region may comprise, for example, a region including oxide and oxynitride. A thin native oxide layer may form on the bottom of each bond pad.

An interposer may comprise any structure for mounting chips. An interposer may include circuitry including metal layers formed over a silicon substrate. Metal layers may comprise aluminum or copper interconnect layers, for example, formed in a dielectric region formed over interposer silicon substrate. Dielectric region may include any number of oxide layers or other dielectric layers. In some aspects, an interposer may be a through-silicon via (TSV) interposer, which may include a number of TSV contacts extending through the interposer silicon substrate to provide conductive connection between metal layer(s) to selected circuitry of a substrate or other structure discussed below. In other aspects, interposer may be configured for wire-bond attachment to a substrate or other structure using bond pads and may thus omit TSV contacts.

Integrated circuit (IC) packages, such as system-on-chip (SOC) and system-in-package (SiP) packages, may include chips and interposers.

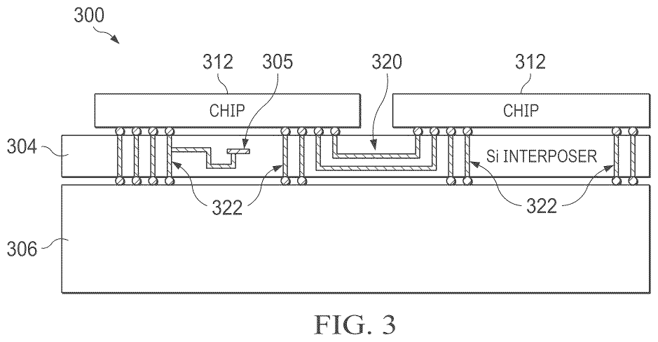

FIG. 3 shows a lateral cross-sectional view of an example multi-chip IC package 300. The IC package 300 includes a plurality of chips 312 mounted (e.g., solder mounted) on an interposer 304, which in turn is mounted (e.g., solder mounted) on a substrate 306. In an example, the IC package 300 may be a field programmable gate array (FPGA) device having an FPGA chip and a memory chip attached to the interposer 304 and/or any other chips or components of an FPGA component. Alternatively, the IC package 300 may be any other type of device, including any number and type(s) of chips 312 mounted on the interposer 304. The chips 312 and the data storage device 305 comprise chip logic. A chip 312 communicates with the data storage device 305 to provide the chip 312 with chip logic sufficient to perform a chip function, which may be a chip function. The data storage device 305 may comprise chip logic for a chip function, so that the chip 312 may not be functional without that logic stored on the data storage device 305 of the interposer 304. Functional chip logic blocks from chips 312 are built into the data storage device 305 of the interposer 304. The chips 312 connected to this interposer 304 may fully function as predicted because the logic is provided by the data storage device 305 of the interposer 304 or a data storage device (not shown) of the substrate 306.

As shown, the interposer 304 may include (a) connections 320 between the plurality of chips 312 (and similar connections between any other chips mounted on the interposer 304) and (b) through-silicon vias (TSVs) 322 extending vertically through the interposer 304 to connect at least one chip 312 to circuitry in the substrate 306 (and in some implementations to circuitry on an underlying PCB on which the IC package 300 is mounted, through TSVs or other connections (not shown), but which extend vertically through substrate 306).

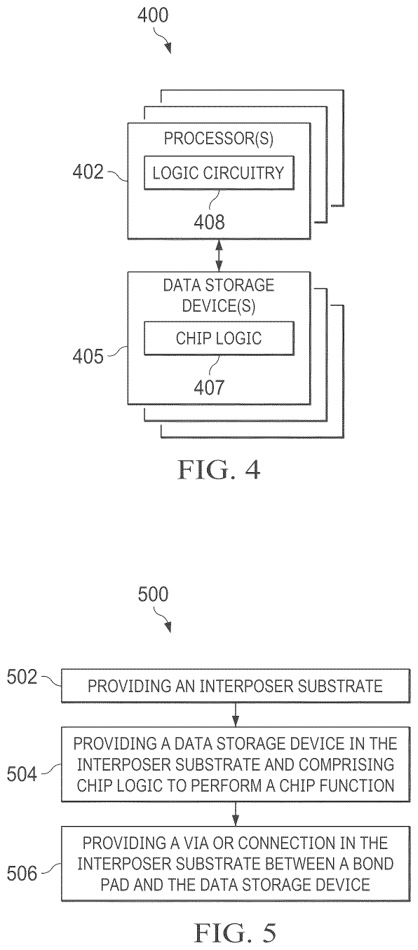

FIG. 4 is a block diagram of circuitry 400 that, in some aspects, may be used to implement various functions, operations, acts, processes, and/or methods disclosed herein. The circuitry 400 includes one or more processors 402 (sometimes referred to herein as “processors 402”) operably coupled to one or more data storage devices (sometimes referred to herein as “data storage device 405”). The data storage device 405 includes chip logic 407 stored thereon and the processors 402 include logic circuitry 408. The chip logic 407 includes information describing functional elements that may be implemented by (e.g., performed by) the logic circuitry 408. The logic circuitry 408 is adapted to implement (e.g., perform) the functional elements described by the chip logic 407. The circuitry 400, when executing the functional elements described by the chip logic 407, may be considered as specific purpose hardware configured for carrying out functional elements disclosed herein. In some aspects the processors 402 may perform the functional elements described by the chip logic 407 sequentially, concurrently (e.g., on one or more different hardware platforms), or in one or more parallel process streams.

When implemented by logic circuitry 408 of the processors 402. the chip logic 407 adapts the processors 402 to perform operations of aspects disclosed herein. A chip 312 (see FIG. 3) may comprise a processor 402. For example, the chip logic 407 may adapt the processors 402 to perform at least a portion or a totality of a chip function. As a specific, non-limiting example, the chip logic 407 may adapt the processors 402 to perform at least a portion of functions discussed herein, such as, a cipher-based secure verification, Public Key Infrastructure (PKI) based certificate verification, a secure boot with symmetric key or public/private key, or a verification of the integrity of the interposer by verifying the power/signal integrity signature.

With reference to FIGS. 3 and 4, the processor 402 may be in the chip 312, and the data storage device 405 may be in the interposer 304 or the substrate 306.

The processors 402 may include a general purpose processor, a specific purpose processor, a central processing unit (CPU), a microcontroller, a programmable logic controller (PLC), a digital signal processor (DSP), an application specific integrated circuit (ASIC), a field-programmable gate array (FPGA) or other programmable logic device. discrete gate or transistor logic, discrete hardware components, other programmable device, or any combination thereof designed to perform the functions disclosed herein. A general-purpose computer including a processor is considered a specific-purpose computer while the general-purpose computer is configured to execute functional elements corresponding to the chip logic 407 (e.g., software code, firmware code, hardware descriptions) related to aspects of the present disclosure. It is noted that a general-purpose processor (may also be referred to herein as a host processor or simply a host) may be a microprocessor, but in the alternative, the processors 402 may include any conventional processor, controller, microcontroller, or state machine. The processors 402 may also be implemented as a combination of computing devices, such as a combination of a DSP and a microprocessor, a plurality of microprocessors, one or more microprocessors in conjunction with a DSP core, or any other such configuration.

In some aspects the data storage device 405 includes volatile data storage (e.g., random-access memory (RAM)), non-volatile data storage (e.g., Flash memory, a hard disc drive, a solid state drive, erasable programmable read-only memory (EPROM), without limitation). In some aspects the processors 402 and the data storage device 405 may be implemented into a single device (e.g., a semiconductor device product, a system on chip (SOC), without limitation). In some aspects the processors 402 and the data storage device 405 may be implemented into separate devices.

In some aspects the chip logic 407 may include computer-readable instructions (e.g., software code, firmware code). By way of non-limiting example, the computer-readable instructions may be stored by the data storage device 405, accessed directly by the processors 402, and executed by the processors 402 using at least the logic circuitry 408. Also by way of non-limiting example, the computer-readable instructions may be stored on the data storage device 405, transferred to a memory device (not shown) for execution, and executed by the processors 402 using at least the logic circuitry 408. Accordingly, in some aspects the logic circuitry 408 includes electrically configurable logic circuitry 408.

In some aspects the chip logic 407 may describe hardware (e.g., circuitry) to be implemented in the logic circuitry 408 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, Verilog™, System Verilog™ or very large scale integration (VLSI) hardware description language (VHDL™) may be used.

HDL descriptions may be converted into descriptions at any of numerous other levels of abstraction as desired. As a non-limiting example, a high-level description can be converted to a logic-level description such as a register-transfer language (RTL), a gate. level (GL) description, a layout-level description, or a mask-level description. As a non-limiting example, micro-operations to be performed by hardware logic circuits (e.g., gates, flip-flops, registers, without limitation) of the logic circuitry 408 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some aspects, the chip logic 407 may include an HDL. an RTL, a GL description, a mask level description, other hardware description, or any combination thereof.

In aspects where the chip logic 407 includes a hardware description (at any level of abstraction), a system (not shown, but including the data storage device 405) may be configured to implement the hardware description described by the chip logic 407. By way of non-limiting example, the processors 402 may include a programmable logic device (e.g., an FPGA or a PLC) and the logic circuitry 408 may be electrically controlled to implement circuitry corresponding to the hardware description into the logic circuitry 408. Also, by way of non-limiting example, the logic circuitry 408 may include hard-wired logic manufactured by a manufacturing system (not shown, but including the data storage device 405) according to the hardware description of the chip logie 407.

Regardless of whether the chip logic 407 includes computer-readable instructions or a hardware description, the logic circuitry 408 is adapted to perform the functional elements described by the chip logic 407 when implementing the functional elements of the chip logic 407. It is noted that although a hardware description may not directly describe functional elements, a hardware description indirectly describes functional elements that the hardware elements described by the hardware description are capable of performing.

FIG. 5 shows a method to protect chip intellectual property disclosed to supply chain foundries and assembly sites. An interposer substrate is provided 502. A data storage device is provided 504 in the interposer substrate and it comprises chip logic to perform a chip function. A via or connection is provided 506 in the interposer substrate between a bond pad and the data storage device.

Although examples have been described above, other variations and examples may be made from this disclosure without departing from the spirit and scope of these disclosed examples.

1. A method comprising:
providing an interposer substrate;
providing a data storage device in the interposer substrate and comprising chip logic to perform a chip function; and
providing a via or connection in the interposer substrate between a bond pad and the data storage device, whereby an interposer is created.

2. The method according to claim 1, comprising providing a chip that does not include the chip logic.

3. The method according to claim 1, comprising assembling the chip and the interposer so that the chip is operable to perform a function of the chip logic via the chip logic of the interposer.

4. The method according to claim 1, wherein the chip logic comprises logic to perform a function of the chip or block a function of the chip.

5. The method according to claim 1, wherein the chip logic comprises cipher-based verification logic to use a symmetric key and a derived key, wherein the symmetric key is to comprise a diversified symmetric key and the derived key is to be derived from a master key.

6. The method according to claim 1, wherein the chip logic comprises Public Key Infrastructure (PKI) based certificate authentication logic.

7. The method according to claim 1, wherein the chip logic comprises logic to boot with a symmetric key or a public/private key.

8. The method according to claim 1, wherein the chip logic comprises logic to verify a power or signal signature of a chip.

9. A device comprising:
an interposer substrate;
a data storage device in the interposer substrate and comprising chip logic to perform a first chip function; and
a via or connection in the interposer substrate between a bond pad and the data storage device.

10. The device according to claim 9, wherein the chip logic comprises logic to perform the first chip function or block performance of a second chip function.

11. The device according to claim 9, wherein the chip logic comprises cipher-based verification logic to use a symmetric key and a derived key, wherein the symmetric key is to comprise a diversified symmetric key and the derived key is to be derived from a master key.

12. The device according to claim 9, wherein the chip logic comprises Public Key Infrastructure (PKI) based certificate authentication logic.

13. The device according to claim 9, wherein the chip logic comprises logic to boot with a symmetric key or a public/private key.

14. The device according to claim 9, wherein the chip logic comprises logic to verify a power or signal signature of a chip.

15. A system comprising:
an interposer comprising:
an interposer substrate;
a data storage device in the interposer substrate and comprising chip logic to perform a first chip function; and
a chip in signal communication with the interposer, wherein the chip does not comprise the chip logic, wherein the chip is to perform a function via the chip logic of the interposer.

16. The system according to claim 15, wherein the chip logic comprises logic to perform the first chip function or block performance of a second chip function.

17. The system according to claim 15, wherein the chip logic comprises cipher-based verification logic to use a symmetric key and a derived key, wherein the symmetric key is to comprise a diversified symmetric key and the derived key is to be derived from a master key.

18. The system according to claim 15, wherein the chip logic comprises Public Key Infrastructure (PKI) based certificate authentication logic.

19. The system according to claim 15, wherein the chip logic comprises logic to boot with a symmetric key or a public/private key.

20. The system according to claim 15, wherein the chip logic comprises logic to verify a power or signal signature of the chip.
